(19) United States
(12) Patent Application Publication
(10) Pub. No.: US 2014/0133818 A1
(43) Pub. Date: May 15, 2014

(54) OPTICAL FIBER FIXING DEVICE

(71) Applicant: HON HAI PRECISION INDUSTRY CO., LTD., (US)

(72) Inventor: HSIN-SHUN HUANG, New Taipei (TW)

(73) Assignee: HON HAI PRECISION INDUSTRY CO., LTD., New Taipei (TW)

(21) Appl. No.: 13/831,888

(22) Filed: Mar. 15, 2013

(30) Foreign Application Priority Data
Nov. 13, 2012 (TW) 101142258

(51) Int. Cl. G02B 6/36

(52) U.S. Cl. CPC G02B 6/3616
USPC 385/134

(57) ABSTRACT

An optical fiber fixing device includes a substrate, a first cover, a second cover, a first buffer, a second buffer, a first locking element, and a second locking element. The substrate includes a loading surface having a first receiving portion and a second receiving portion. The first receiving portion and the second receiving portion each define receiving grooves for receiving the optical fibers. The first cover and the second cover are rotatably connected to two opposite ends of the substrate. The first buffer is fixed to the first cover, and presses the optical fibers in the receiving grooves of the first receiving portion. The second buffer is fixed to the second cover, and presses the optical fibers in the receiving grooves of the second receiving portion. The first locking element locks the first cover and the substrate together. The second locking element locks the second cover and the substrate together.

### BACKGROUND

1. Technical Field

The present disclosure relates to fixing devices, and particularly to an optical fiber fixing device.

2. Description of Related Art

Currently, an optical fiber fixing device can fix only one optical fiber at a time, then the optical fiber fixing device is mounted on a detecting machine to detect the optical performance of optical fiber. However, when a number of optical fibers need to be detected, the optical fiber fixing device must be detached from the detecting machine many times, which will reduce the detecting efficiency.

Therefore, it is desirable to provide an optical fiber fixing device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of an optical fiber fixing device, according to an exemplary embodiment, showing the optical fiber fixing device in a closed state.

FIG. 2 is similar to FIG. 1, but showing the optical fiber fixing device in an open state.

### DETAILED DESCRIPTION

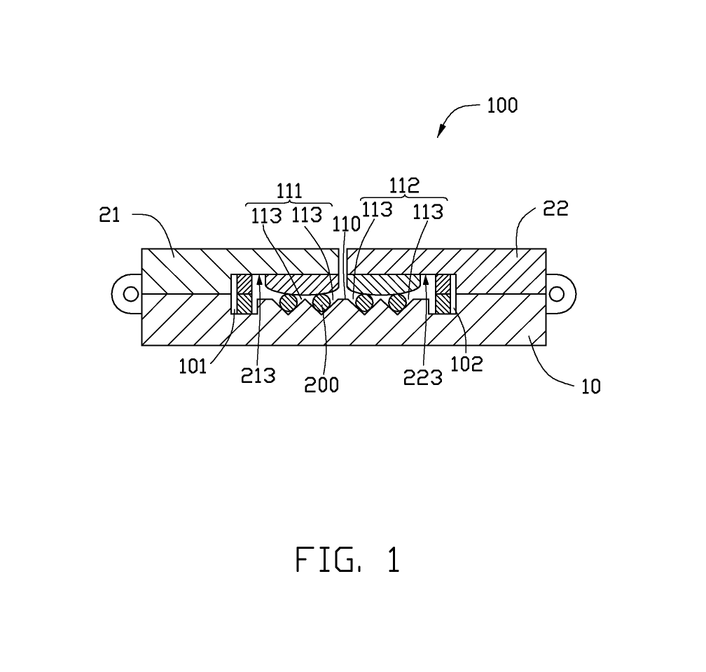

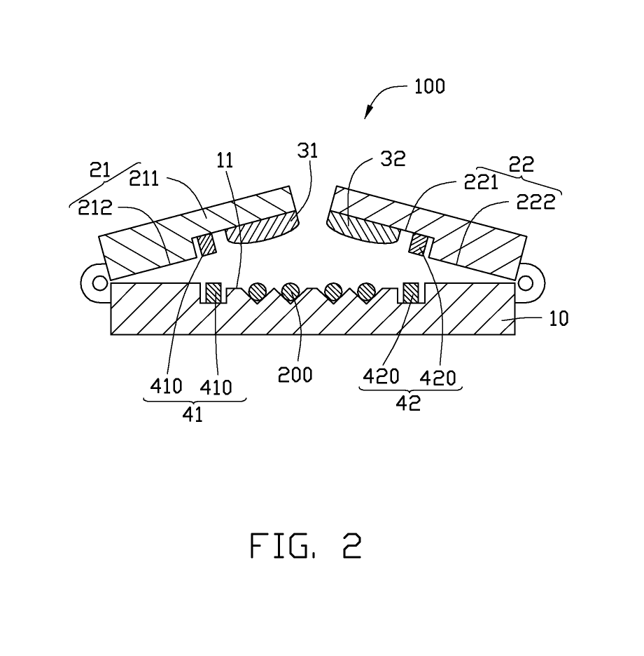

FIGS. 1 and 2 illustrate an optical fiber fixing device 100 in accordance to an embodiment. The optical fiber fixing device 100 is used for fixing a number of optical fibers 200 at one time. The optical fiber fixing device 100 includes a substrate 10, a first cover 21, a second cover 22, a first buffer 31, a second buffer 32, a first locking assembly 41, and a second locking assembly 42.

The substrate 10 is substantially cubic, and includes a loading surface 11. The loading surface 11 includes a separator 110, a first receiving portion 111, and a second receiving portion 112. The first receiving portion 111 and the second receiving portion 112 are positioned on two opposite sides of the separator 110, and are symmetrical about the separator 110. Both of the first receiving portion 111 and the second receiving portion 112 define a number of receiving grooves 113 evenly spaced with each other. The extending directions of the receiving grooves 113 are parallel to each other. Each receiving groove 113 is used for receiving an optical fiber 200. Along a direction perpendicular to the lengthwise direction of the optical fibers 200, the cross-sections of the receiving grooves 113 are V-shaped.

The loading surface 11 further defines a first slot 101 and a second slot 102. The first receiving portion 111 and the second receiving portion 112 are positioned between the first slot 101 and the second slot 102. The first slot 101 and the first receiving portion 111 are positioned on a same side of the separator 110. The second slot 102 and the second receiving portion 112 are positioned on the other side of the separator 110.

The first cover 21 and the second cover 22 are rotably connected to the substrate 10. The first cover 21 includes a first fixing portion 211 and a first connecting portion 212 perpendicularly connected to the first fixing portion 211. The first fixing portion 211 is corresponding to the first receiving portion 111, and includes a first fixing surface 213 facing the first receiving portion 111.

The second cover 22 includes a second fixing portion 221 and a second connecting portion 222 perpendicularly connected to the second fixing portion 221. The second fixing portion 221 is corresponding to the second receiving portion 112, and includes a second fixing surface 223 facing the second receiving portion 112. The first connecting portion 212 and the second connecting portion 222 are rotably connected on two opposite ends of the substrate 10.

The first buffer 31 is positioned on the first fixing surface 213, and is used for fixing the optical fibers 200 in the corresponding receiving groove 113 of the first receiving portion 111. The second buffer 32 is positioned on the second fixing surface 223, and is used for fixing the optical fibers 200 in the corresponding receiving grooves 113 of the second receiving portion 112. The first buffer 31 and the second buffer 32 are used for preventing the optical fibers 200 from damage. In this embodiment, the first buffer 31 and the second buffer 32 are foams.

The first locking assembly 41 is used for fixing the first cover 21 to the substrate 10, and includes two first magnetic elements 410 attracted to each other. The two first magnetic elements 410 are aligned with each other, and are fixed on the first cover 21 and the substrate 10 respectively. In this embodiment, one of the two first magnetic elements 410 is fixed to the first fixing surface 213, and the other one of the two first magnetic elements 410 is fixed in the first slot 101.

The second locking assembly 42 is used for fixing the second cover 22 to the substrate 10, and includes two second magnetic elements 420 attracted to each other. The two second magnetic elements 420 are aligned with each other, and are fixed on the second cover 22 and the substrate 10 respectively. In this embodiment, one of the two second magnetic elements 420 is fixed on the second fixing surface 223, and the other one of the two second magnetic elements 420 is fixed in the second slot 102.

In use, each receiving groove 113 receives one of the optical fibers 200, the first locking assembly 41 locks the first cover 21 and the substrate 10 together, and the second locking assembly 42 locks the second cover 22 and the substrate 10 together, and thus the first buffer 31 presses the corresponding optical fibers 200 in the receiving grooves 113 of the first receiving portion 111, the second buffer 32 presses the corresponding optical fibers 200 in the receiving grooves 113 of the second receiving portion 112. At last, the optical fiber fixing device 100 can be mounted on the detecting device to detect the optical performance of the optical fibers 200.

The optical fiber fixing device 100 can fix a number of optical fibers 200 at one time, and thus the detecting efficiency of the optical fibers 200 can be improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical fiber fixing device for fixing a plurality of optical fibers, comprising:
a substrate having a loading surface, wherein the loading surface comprises a first receiving portion and a second receiving portion, each of the first receiving portion and the second receiving portion defines a plurality of receiving grooves, each of the receiving grooves is configured for receiving one of the optical fibers;
a first cover having a first fixing surface facing the first receiving portion and corresponding to the first receiving portion;
a second cover having a second fixing surface facing the second receiving portion and corresponding to the second receiving portion, wherein the first cover and the second cover are rotably connected to two opposite ends of the loading surface;
a first buffer fixed to the first fixing surface, and configured for pressing the optical fibers in the receiving grooves of the first receiving portion;
a second buffer fixed to the second fixing surface, and configured for pressing the optical fibers in the receiving grooves of the second receiving portion;
a first locking assembly for locking the first cover and the substrate together; and
a second locking assembly for locking the second cover and the substrate together.

2. The optical fiber fixing device of claim 1, wherein the loading surface comprises a separator, the first receiving portion and the second receiving portion are positioned on two opposite sides of the separator, and are symmetric about the separator.

3. The optical fiber fixing device of claim 1, wherein the receiving grooves are evenly spaced and separated from each other.

4. The optical fiber fixing device of claim 1, wherein along a direction perpendicular to a lengthwise direction of the optical fibers, cross-sections of the receiving grooves are V-shaped.

5. The optical fiber fixing device of claim 1, wherein extending directions of the receiving grooves are parallel to each other.

6. The optical fiber fixing device of claim 1, wherein the first cover comprises a first fixing portion and a first connecting portion connected to the first fixing portion, the first fixing portion has the first fixing surface, and the first connecting portion is rotably connected to the substrate; the second cover comprises a second fixing portion and a second connecting portion connected to the second fixing portion, the second fixing portion has the second fixing surface, and the second connecting portion is rotably connected to the substrate.

7. The optical fiber fixing device of claim 1, wherein the first buffer and the second buffer are made of foams.

8. The optical fiber fixing device of claim 1, wherein the first locking element comprises at least two first magnetic elements, one of the at least two first magnetic elements is positioned on the first fixing surface, and another one of the at least two first magnetic elements is positioned on the substrate.

9. The optical fiber fixing device of claim 8, wherein the second locking element comprises at least two second magnetic elements, one of the at least two second magnetic elements is positioned on the second fixing surface, and another one of the at least two second magnetic elements is positioned on the substrate.

10. The optical fiber fixing device of claim 9, wherein the loading surface defines a first slot and a second slot, the first receiving portion and the second receiving portion are positioned between the first slot and the second slot, one of the at least two first magnetic elements is received in the first slot, one of the at least two second magnetic elements is received in the second slot.
